(19) United States
(12) Patent Application Publication
(10) Pub. No.: US 2023/0402961 A1
(43) Pub. Date: Dec. 14, 2023

(54) Dual-Axis Solar Tracker with Hybrid Control and Possibility of Full Rotation

(71) Applicant: Vahid FAKHARI, Hakimieh, Tehran (IR)

(72) Inventors: Vahid Fakhari, Tehran (IR); Amir Saman Mirjalili, Tehran (IR)

(21) Appl. No.: 18/249,063

(22) PCT Filed: Apr. 22, 2021
(86) PCT No.: PCT/IB2021/053328

§ 371 Date: Apr. 14, 2023

(30) Foreign Application Priority Data
Oct. 16, 2020 (IR) 13995014000300645

(51) Int. Cl. H02S 20/32; F24S 30/455; F24S 50/20

(52) U.S. Cl. CPC H02S 20/32; F24S 30/455; F24S 50/20; F24S 2030/18

(57) ABSTRACT

In this invention, a dual-axis solar tracker is presented to increase the energy produced by solar panels. The control strategy of this tracker is based on a hybrid of both astronomical algorithms and optical sensors and is designed in such a way that both actuators are not active at the same time. Also, the mechanical structure of the tracker is such that it is possible to rotate the solar panel 360 degrees around both axes. This makes it possible to track the sun in the early or late hours of the day or in some geographical areas where the direction of the sun ray is significantly inclined. Furthermore, the invented tracker consists of modular and ready-made mechanical and electronic components, and all the connections are in the form of bolts and nuts, which makes it fast and easy to assemble, install, disassemble and transport while having sufficient strength.

### TECHNICAL FIELD

This invention is related to presenting novel structure and control strategies for dual-axis solar trackers to increase the electrical energy produced by solar panels.

### BACKGROUND ART

Today, renewable energy sources such as solar energy have attracted a lot of attention due to the pollution caused by fossil fuels. The process of converting solar energy into electrical energy can be done by photovoltaic panels or concentrated solar power systems. The power generated by these systems depends on several factors, such as the amount of radiation received. Because the sun's position changes throughout the day, using a solar tracker is a proven way to increase the generated power. The function of solar trackers is to follow the sun so that the sun rays are perpendicular to the solar panel at all times.

To track the sun's position, different control strategies have been employed for the solar trackers. These control strategies can be categorized into three groups: Control strategies based on astronomical algorithms, Control strategies based on optical sensors, and Hybrid strategies.

Control Strategies Based on Astronomical Algorithms (Open-Loop Control): In these methods, according to the geographic latitude and longitude of the region, the position of the sun at any hour of the day is calculated and then the necessary command signals are sent to actuators to rotate the solar panel around two axes. One of the limitations related to these strategies is the existence of computational errors in astronomical algorithms to find the exact position of the sun. This matter causes the tracker not to accurately follow the sun and reduces the efficiency of the tracker. Another limitation relates to cases that possible external disturbances (such as wind or impact) are applied to the tracker and divert the solar panel from the correct position. In these cases, due to the lack of feedback from the sensors, tracking of the sun is done with considerable error, and therefore the amount of energy produced by the tracker is reduced.

Control strategies based on optical sensors (Closed-loop control): In these methods, using optical sensors, the exact position of the sun (direction of sun rays) is determined, and based on it, the necessary command signals are sent to the actuators to rotate the solar panel around two axes. Therefore, in these methods, despite the presence of external disturbances (such as wind or impact), sun-tracking is done relatively accurately. But the main limitation of these methods is when the weather is cloudy and the position of the sun cannot be detected by sensors.

Hybrid control strategies (open-loop and closed-loop control): In these methods, a combination of astronomical control methods and control methods based on optical sensors are used to take advantage of both methods simultaneously.

Solar trackers are available in one-axis and dual-axis types. Dual-axis solar trackers can track the sun more accurately and therefore produce more energy.

In existing dual-axis solar trackers, there are some technical problems related to their control strategy, rotation of the panel and, simplicity of assembling/installing. These limitations will be mentioned in detail in the section “Technical Problem”. In this invention, the mentioned technical problems are fixed.

### SUMMARY OF INVENTION

In this invention, a novel and unique hybrid control strategy is proposed for the tracker that while tracking the sun relatively accurately, most of the time in a day, both actuators are not active simultaneously. Therefore the energy consumption of the actuators will be reduced and the net energy produced by the tracker will be increased.

In this invention, a novel mechanical structure is proposed for the dual-axis solar tracker so that it has no motion limitations and makes it possible to rotate the solar panel completely (360 degrees) around both axes.

In this invention, modular and ready-made mechanical and electronic components are used and all the connections of its components are in the form of bolts and nuts. This makes it fast and easy to assemble, install and operate the tracker while having sufficient strength. Also, the tracker can be disassembled and transported quickly and easily.

### Technical Problem

In existing dual-axis solar trackers, there are some technical problems that are elaborated as follows:
Problem 1—One of the problems of existing dual-axis solar trackers is related to their motion control strategies. In all the hybrid control strategies proposed to control the motion of dual-axis solar trackers, both actuators are involved simultaneously and/or sensor-based sun tracking (which consumes energy for supplying sensors and the microcontroller) is active all the time in a day. In this case, the energy consumption of the tracker is relatively high, which reduces its efficiency.
Problem 2—Another problem with dual-axis solar trackers is the limitation on the rotation of the panel around two axes due to the physical structure of the trackers. In other words, in existing dual-axis solar trackers, full rotation (360 degrees) of the solar panel around one or both axes is not possible. This makes it impossible to track the sun in some early or late hours of the day when the direction of sun rays is significantly inclined. On the other hand, the limited rotation of the panel in solar trackers makes them unable to effectively track the sun in all geographical regions. For example, in areas close to the North or South Poles, where the direction of the sun ray is inclined during most of the day, the sun is not tracked well.
Problem 3—Another problem with most existing dual-axis solar trackers is that their components cannot be disassembled, transported, assembled, installed, and setting up quickly and easily.

### Solution to Problem

In this invention, some solutions are proposed to fix the problems mentioned in the previous section as follows:

The Solution to Problem 1—To solve problem 1, a novel and unique hybrid control strategy is proposed that while tracking the sun relatively accurately, only once a day, both actuators are involved simultaneously and at other times in a day, one of the actuators is active. Moreover, the sensor-based sun tracking that consumes energy for supplying the microcontroller and sensors is active once a day. Therefore the energy consumption of the tracker will be reduced and the net energy produced by the tracker will be increased.

In the proposed control strategy in this invention, a declination-hour angle tracking concept is employed. In this concept, the panel is rotated around two axes based on the values of declination and hour angles to be located perpendicular to the sun rays. In this concept, one of the axes of rotation is parallel to the horizontal plane in the north-south direction (called the hour axis) which is used for rotating the panel based on the hour angle. The other axis of rotation is parallel to the horizontal plane in the east-west direction (called the declination axis) which is employed to rotate the panel according to the declination angle.

During a day, variations in the declination angle are relatively small. Therefore, the declination angle can be considered constant and adjusted one time in a day using one of the actuators, when the tracker starts to operate. However, the variations in the hour angle are relatively large and should be adjusted repeatedly during a day using one of the actuators. In this way, only one actuator will be involved which increases the efficiency of the tracker.

Also, to make corrections on the position of the solar panel due to the inaccuracy of astronomical algorithms or external disturbances applied to the tracker (such as wind or impact), one time in the day, at midday, corrections are made to the position of the solar panel by activating both actuators according to the feedback is received from optical sensors. In this way, only one time in a day, both actuators will be involved simultaneously and also, the sensor-based sun tracking that consumes energy for supplying the microcontroller and sensors will be active once a day.

According to paragraphs [0019] and [0020], by employing the proposed control strategy in this invention, only one time in a day, both actuators will be involved simultaneously and at other times in a day, only one actuator is active. Moreover, the sensor-based sun tracking that consumes energy for supplying the microcontroller and sensors will be active once a day. Therefore, by using this strategy, the energy consumption of the tracker will be reduced and the net energy produced by the tracker will be increased.

The proposed control strategy comprises:
One time in a day, when the tracker starts to operate, rotating the solar panel around the declination axis by activating one of the actuators based on the declination angle computed by astronomical algorithms;
During the day, rotating the solar panel around the hour axis by activating one of the actuators according to the hour angle computed by astronomical algorithms;
One time in the day, at midday, making corrections to the position of the solar panel by activating both actuators according to feedback received from optical sensors to compensate for position errors made by the inaccuracy of astronomical algorithms or external disturbances, such as wind or impact.

The Solution to Problem 2—In this invention, a novel mechanical structure is presented for the dual-axis solar tracker that allows the 360-degree rotation of the solar panel around both axes. This makes it possible to use the tracker with remarkable efficiency at all hours of the day as well as in all geographical regions.

The Solution to Problem 3—In this invention, modular and ready-made mechanical and electronic components are used for the tracker and all the connections of the components are in the form of bolts and nuts, which makes it fast and easy to assemble, install and operate, while having sufficient strength. Also, the tracker can be disassembled and transported quickly and easily.

### Advantageous Effects of Invention

The dual-axis solar tracker presented in this invention has the following advantages over previous patent and non-patent literature:
Advantage 1—In this invention, a new and unique hybrid control strategy is presented for dual-axis solar trackers that while tracking the sun relatively accurately, only once a day, both actuators are involved simultaneously and at other times in a day, one of the actuators is active. Moreover, the sensor-based sun-tracking that consumes energy for supplying the microcontroller and sensors is active once a day. Therefore the energy consumption of the tracker will be reduced and the net energy produced by the tracker will be increased. While in other hybrid control strategies presented for dual-axis solar trackers in previous patent and non-patent literature, both actuators are involved at the same time, and/or sensor-based sun tracking is active all the time in a day. Therefore, the energy consumption of the tracker will be higher and the net energy produced by the tracker will be lower.
Advantage 2—The dual-axis solar tracker presented in this invention has a new mechanical structure that allows the 360-degree rotation of the solar panel around both axes. This allows the tracker to be used with remarkable efficiency at all hours of the day as well as in all geographical regions. While in other dual-axis solar trackers presented in previous patent and non-patent literature, due to the mechanical structure, there is a limitation on the rotation of the solar panel around one or both axes. This makes it impossible to track the sun in some early or late hours of the day or in some geographical areas where the direction of the sun ray is significantly inclined.
Advantage 3—In this invention, modular and ready-made mechanical and electronic components are used for the dual-axis solar tracker and all the connections of its components are in the form of bolts and nuts, which makes it fast and easy to assemble, install and set up while having sufficient strength. Also, it can be disassembled and transported quickly and easily. While in most dual-axis solar trackers presented in previous patent and non-patent literature, their components cannot be disassembled, transported, assembled, installed and, setting up quickly and easily.

### BRIEF DESCRIPTION OF DRAWINGS

FIG. 1 shows the front and side view of the dual-axis solar tracker including its components.

FIG. 2 illustrates the bottom view of the dual-axis solar tracker including its components.

FIG. 3 depicts the isometric view of the dual-axis solar tracker including its components.

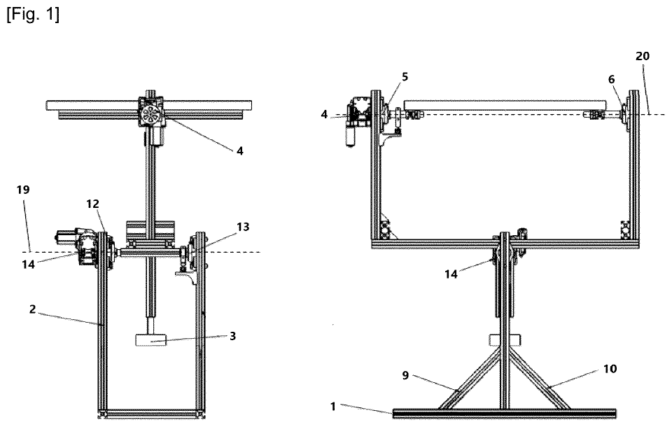

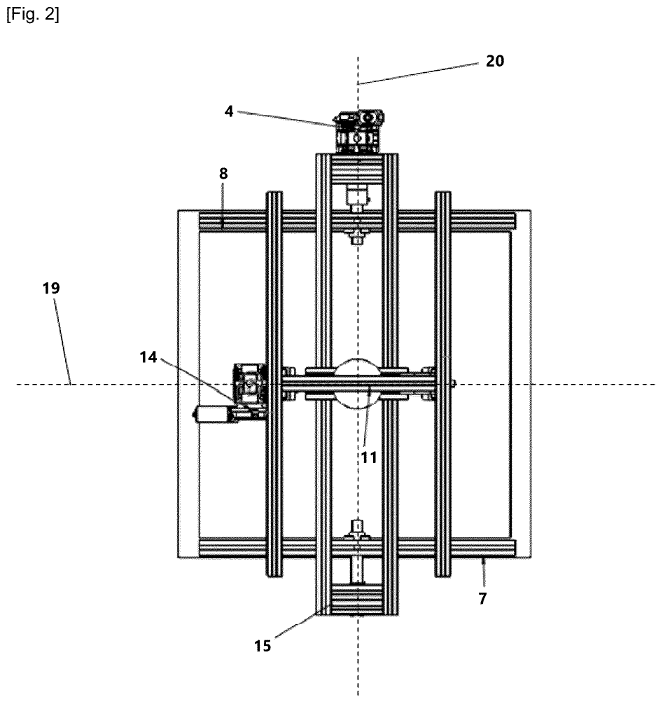

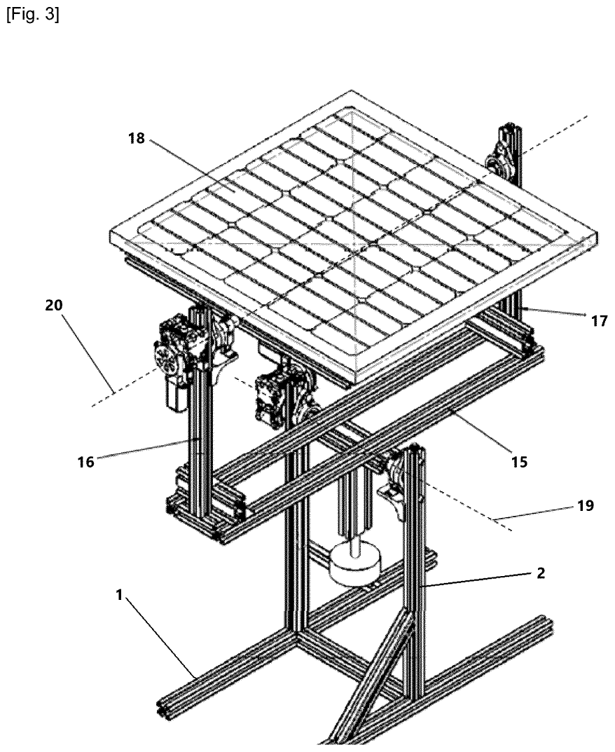

### DESCRIPTION OF EMBODIMENTS

[FIG. 1], [FIG. 2] and [FIG. 3] show different views of the dual-axis solar tracker and its components.

According to these figures, a lower frame includes a horizontal H-shaped structure (1) and a vertical U-shaped structure (2) to support the total weight of the tracker.

An upper frame includes a rectangular structure (15), columns (16) and (17), and a counterweight (3).

A DC motor with worm gearbox (14) rotates the upper frame about a declination axis (19) only once a day based on the declination angle computed by astronomical algorithms, adjusting its position.

Also, a DC motor with worm gearbox (4) rotates a solar panel (18), mounted on aluminum profiles (7) and (8), around an houa axis (20) during the day accourding to the hour angle computed by astronomical algorithms, adjusting its position.

In this tracker, worm gearboxes with an inherent mechanical self-locking feature are used to make the DC motors safe from damages caused by a person or environment. Also, the mentioned feature prevents the rotation of the solar panel (18) and the upper frame not within their defined rotation angles due to the deactivation of DC motors, gravity, or wind.

It should be noted that bearings (5), (6), (12), and (13) are used to minimize friction against the rotation of the solar panel (18) and the upper frame about the rotation axes (20) and (19).

The counterweight (3) is used to reduce the resistant torque (due to gravity) applied to the DC motor with worm gearbox (14).

Aluminum profiles (9) and (10) with a slope of 45 degrees are used to strengthen the vertical columns of the U-shaped structure (2).

The upper frame is attached to an aluminum profile (11). The long columns (16) and (17) are installed on the rectangular (15).

The length of the columns (16) and (17) is more than half of the length of the solar panel (18) to be long enough to provide a suitable space for the 360-degree rotation of the solar panel (18) around the axis (20).

The length of the vertical coulumns of the U-shaped structure (2) is more than half of the length of the rectangular structure (15) to be long enough to provide a suitable space for a 360-degree rotation of the upper frame around the axis (19).

All of the connections are in the form of bolts and nuts.

In this tracker, the solar panel (18) can be rotated 360 degrees about both axes, and also, due to the use of bolt-nut connections, it can be assembled, disassembled, and transported easily and quickly.

### INDUSTRIAL APPLICABILITY

The presented tracker in this invention can be used to increase the efficiency of solar panels in remote or impassable areas that face problems such as the transmission of electrical energy and electricity shortage.

In this tracker, the solar panel can be rotated 360 degrees, and therefore, it will be effective in early or late hours of the day when the direction of sun rays is significantly inclined. Also, this tracker will be effective in all geographical regions, even in areas close to the North or South Poles, where the direction of the sun ray is inclined during most of the day.

This tracker can be installed on the roof of the houses or industrial units to provide the required electricity. Also, it can be redesigned to control a group of solar panels and therefore can be widely implemented in solar farms to increase the generated power.

### REFERENCE SIGNS LIST

### Reference to Deposited Biological Material

### Sequence Listing Free Text

### Citation List

PTL1: US Patent Application 2019/0190441 A1, “Dual Axis Solar Tracking System”, Publication Date: Jun. 20, 2019.

PTL2: U.S. Pat. No. 8,895,836 B2, “Dual Axis Solar Tracking Apparatus and method”, Date of Patent: Nov. 25, 2014.

PTL3: US Patent Application 2019/0253020 A1, “Solar Tracker and Solar Energy Collection System”, Publication Date: Aug. 15, 2019.

PTL4: CA Patent CA139970S, “Dual axis solar tracker”, Publication Date: Jan. 31, 2012.

NPL1: Yao, Y., Hu, Y., Gao, S., Yang, G., & Du, J. (2014). A multipurpose dual-axis solar tracker with two tracking strategies. Renewable Energy, 72, 88-98.

NPL2: Robles Algarin, C. A., Ospino Castro, A. J., & Naranjo Casas, J. (2017). Dual-axis solar tracker for using in photovoltaic systems. International Journal of Renewable Energy Research, 7 (1), 139-145.

NPL3: Alexandru, C. (2013). A novel open-loop tracking strategy for photovoltaic systems. The Scientific World Journal, pp. 1-12.

### PATENT LITERATURE

As mentioned in section “Background Art”, hybrid control strategies are more effective in comparison with open-loop and closed-loop strategies. Furthermore, dual-axis solar trackers can generate more electrical energy in comparison with one-axis trackers.

In all the hybrid strategies proposed to control the motion of dual-axis solar trackers, both actuators are involved simultaneously, which reduces the efficiency of the tracker. Also, in existing dual-axis solar trackers, full rotation (360 degrees) of the solar panel around one or both axes is not possible. This makes it impossible to track the sun in some early or late hours of the day or in geographical regions, where the direction of the sun ray is inclined during most of the day. Furthermore, components in most existing dual-axis solar trackers cannot be disassembled, transported, assembled, installed, and setting up quickly and easily.

Currently, various mechanisms and control strategies have been presented for dual-axis solar trackers in patent and non-patent literature:

PTL1 discloses a mechanism for a dual-axis solar tracker that has limitations on rotation about one of the axes. The dual-axis solar tracker described in PTL2 employs an open-loop control strategy based on astronomical algorithms. Also, this patent has limitations on rotation about both axes.

PTL3 presents a dual-axis solar tracker with the azimuth-elevation mechanism. The related control strategy is in a way that both actuators are involved simultaneously and therefore power consumption of the actuator will be high that reduces the net generated electric energy.

PTL4 discloses a mechanism for a dual-axis solar tracker that has limitations on rotation about both axes. Furthermore, according to the control strategy presented in this patent, both actuators are active simultaneously that reduces the efficiency of the tracker.

### Non Patent Literature

In NPL1, a mechanism for a dual-axis solar tracker is presented that has a limitation on rotation about one of the axes. Also, in this mechanism, it will be possible that in some hours of the day, the structure of the tracker cast a shadow on the solar panel that reduces the efficiency of the tracker.

In the dual-axis solar trackers presented in NPL2 and NPL3, limitations on rotation about both axes are observable.

What is claimed is:

1-5. (canceled)

6. A dual-axis solar tracker, comprising:
A lower frame including a horizontal H-shaped structure (1) and a vertical U-shaped structure (2) to support the total weight of the tracker;
An upper frame including a rectangular structure (15), columns (16) and (17), and a counterweight (3);
The upper frame being attached to the lower frame to rotate around an east-west axis (19);
Vertical columns of the U-shaped structure (2) with lengths more than half of the length of the rectangular structure (15) being long enough to allow a 360-degree rotation of the upper frame around the east-west axis (19);
A solar panel (18) being attached to the upper frame to rotate around a north-south axis (20);
The columns (16) and (17) with lengths more than half of the length of the solar panel (18) being long enough to allow a 360-degree rotation of the solar panel (18) around the north-south axis (20);
Two DC motors with gearboxes (4) and (14) to rotate the solar panel (18) and the upper frame around the rotation axes (20) and (19); and
A method for controlling the dual-axis solar tracker being applied by activation of both of the DC motors once a day; activation of one of the DC motors at other times in a day; activation of a sensor-based sun tracking once a day.

7. The dual-axis solar tracker according to claim 1, wherein worm gearboxes with an inherent mechanical self-locking feature are used to make DC motors safe from damages caused by a person or environment and also, prevent the rotation of the solar panel (18) and the upper frame (15) not within their defined rotation angles due to the deactivation of DC motors, gravity, or wind.

8. The dual-axis solar tracker according to claim 1, wherein the upper and lower frames comprise connections of components; the connections of components are in the form of bolts and nuts.

9. The method for controlling the dual-axis solar tracker according to claim 1, comprising:
Rotating the upper frame around the east-west axis (19) using the DC motor with gearbox (14) once a day, when the tracker starts to operate, based on a declination angle computed by astronomical algorithms;
Rotating the solar panel (18) around the north-south axis (20) using the DC motor with gearbox (4) during the day, according to an hour angle computed by astronomical algorithms;
Making corrections to the position of the solar panel (18) using both of the DC motors (4) and (14) once a day, at midday, according to the feedback received from optical sensors to compensate for the possible position errors made by the inaccuracy of astronomical algorithms or external disturbances, such as wind or impact.
